(19) United States
(12) Patent Application Publication
(10) Pub. No.: US 2023/0221153 A1
(43) Pub. Date: Jul. 13, 2023

(54) DEVICE, METHOD AND PROGRAM FOR DETECTING MICROBEND

(71) Applicant: NIPPON TELEGRAPH AND TELEPHONE CORPORATION, Tokyo (JP)

(72) Inventors: Kazutaka NOTO, Musashino-shi, Tokyo (JP); Nazuki HONDA, Musashino-shi, Tokyo (JP); Hiroyuki OSHIDA, Musashino-shi, Tokyo (JP)

(73) Assignee: NIPPON TELEGRAPH AND TELEPHONE CORPORATION, Tokyo (JP)

(21) Appl. No.: 17/928,264

(22) PCT Filed: Jun. 3, 2020
(86) PCT No.: PCT/JP2020/021887

§ 371 Date: Nov. 28, 2022

(51) Int. Cl. G01D 21/02; G01M 11/02

(52) U.S. Cl. CPC G01D 21/02; G01M 11/02; G01M 11/3109

(57) ABSTRACT

The present disclosure is directed to enabling detection of microbending even in a case where a microbending loss varies.

The present disclosure relates to a device that measures a transmission loss in a measured optical fiber to be targeted, and detects microbending in the measured optical fiber based on periodicity of the transmission loss.

### TECHNICAL FIELD

The present disclosure relates to an optical fiber maintenance operation.

### BACKGROUND ART

Microbending may occur in a degraded optical fiber. In particular, a loss due to microbending varies gradually over time, and thus it is important to detect and predict a microbending loss in an optical fiber maintenance operation. As a method for detecting a microbending loss, there is a method of measuring a transmission loss using an Optical Time Domain Reflectometer (OTDR) or measuring an optical loss using an optical power meter.

### CITATION LIST

### Non-Patent Literature

Non-Patent Literature 1: Hirofumi Amano, “All About Access Networks”, p. 52, The Telecommunications Association, Jul. 1, 2017

Non-Patent Literature 2: Hiroshi Takahashi, et al., “Branched Optical Fiber Loss Measurement Technology for End-to-end Testing in Optical Access Networks”, NTT Technical Journal, December, 2017, pp. 58-62.

### SUMMARY OF THE INVENTION

### Technical Problem

However, a microbending loss is dependent on temperature, so that the microbending loss increases or decreases in a laying environment with a temperature change. Therefore, in detection of a microbending loss based on a threshold, the microbending loss that has actually occurred cannot be detected in some cases.

Accordingly, the present disclosure is directed to enabling detection of microbending even in a case where a microbending loss varies.

### Means for Solving the Problem

A device and method according to the present disclosure measure a transmission loss in a measured optical fiber to be targeted with an OTDR, and detect microbending in the measured optical fiber based on periodicity of a change over time of the transmission loss.

A program of the present disclosure is a program that causes a computer to function as functional units included in a communication device according to the present disclosure, and also causes the computer to execute steps included in a communication method to be executed by a communication device according to the present disclosure.

### Effects of the Invention

The present disclosure is directed to detecting microbending in an optical fiber even in a case where a microbending loss varies.

### BRIEF DESCRIPTION OF DRAWINGS

FIGS. 1A and 1B are examples of a difference in a change over time of a transmission loss due to the presence or absence of microbending; FIG. 1A illustrates a case where microbending is present, and FIG. 1B illustrates a case where microbending is not present.

FIGS. 2A and 2B are examples of a difference in an autocorrelation coefficient due to the presence or absence of microbending; FIG. 2A illustrates a case where microbending is present, and FIG. 2B illustrates a case where microbending is not present.

FIG. 3 illustrates an example of predicting a change in transmission loss due to microbending using a SARIMA model.

FIG. 4 illustrates an example of a difference between a linear approximation and the SARIMA model in prediction of a change in transmission loss due to microbending.

FIG. 5 illustrates a system configuration example according to a first embodiment.

FIG. 6 illustrates an example of a microbending detection method according to the first embodiment.

FIG. 7 illustrates an example of a method for predicting a change in transmission loss due to microbending according to the first embodiment.

FIG. 8 illustrates an example of a microbending detection method according to a second embodiment.

FIG. 9 illustrates a first system configuration example according to the second embodiment.

FIG. 10 illustrates a second system configuration example according to the second embodiment.

FIG. 11 illustrates an example of a method for predicting a change in transmission loss due to microbending according to the second embodiment.

### DESCRIPTION OF EMBODIMENTS

Embodiments of the present disclosure will be described in detail below with reference to the drawings. The present disclosure is not limited to the embodiments shown below. These embodiments are merely examples and the present disclosure can be carried out with various modifications and improvements being made thereto based on knowledge of a person skilled in the art. Note that components in the description that are identical to those in the drawings are denoted by the same reference numerals.

<Principle>

If degradation or characteristic charge occurs in a coating that protects an optical fiber due to an external factor, random minute bends occur in the optical fiber, which causes a microbending loss. As the characteristics of the coating that covers the optical fiber vary depending on temperature, the microbending loss also varies depending on temperature. Therefore, the microbending loss also varies due to a temperature change throughout the day or a temperature change throughout the year. The present disclosure detects microbending in the optical fiber using that change, and predicts a change over time of a transmission loss.

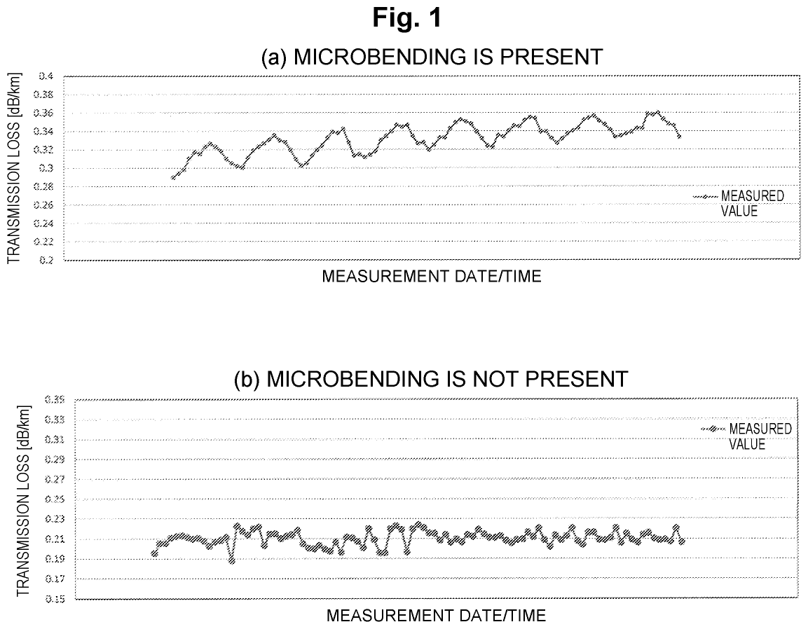

FIGS. 1A and 1B each illustrate an example of a change over time of a transmission loss. It can be seen that the transmission loss in the optical fiber in which microbending has occurred tends to increase with a lapse of time and periodically changes. The change is a seasonal variation, and the main factor of the seasonal variation is a temperature change. Accordingly, the change is a change in microbending loss, and microbending can be detected by detecting the periodicity of the change. Also, in prediction of the microbending loss, the prediction accuracy can be improved by taking the periodicity into consideration. Therefore, as described below, the present disclosure detects microbending in an optical fiber and predicts a change over time of the transmission loss using the periodicity of a change in transmission loss.

Detection of Periodicity using Autocorrelation

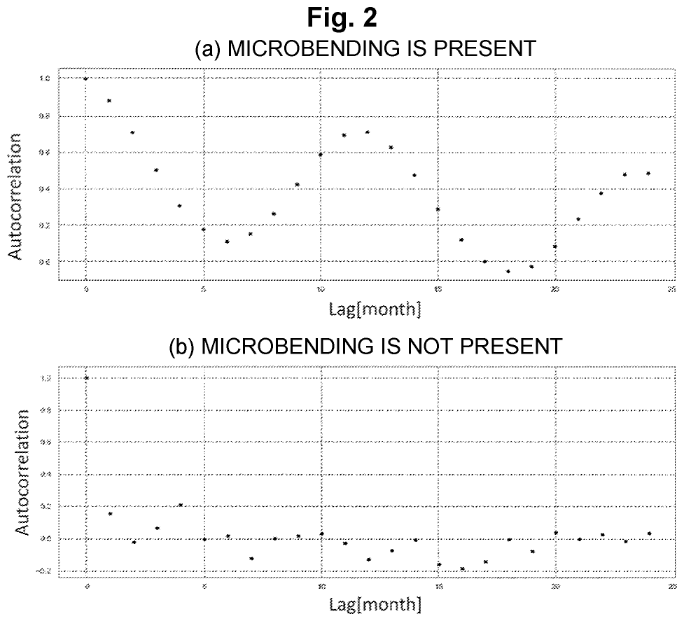

As illustrated in FIGS. 2A and 2B, if calculation of autocorrelation is carried out on a change over time of a transmission loss, a peak appears when the periodicity is present, while no peak appears when the periodicity is not present. The present disclosure can adopt a mode in which an autocorrelation coefficient of a change over time of a transmission loss is calculated and microbending is detected using a peak that appears in the coefficient. Any mode for detecting the presence or absence of the periodicity can be adopted. For example, Fourier transform may be used in addition to the autocorrelation.

Prediction using Autoregression

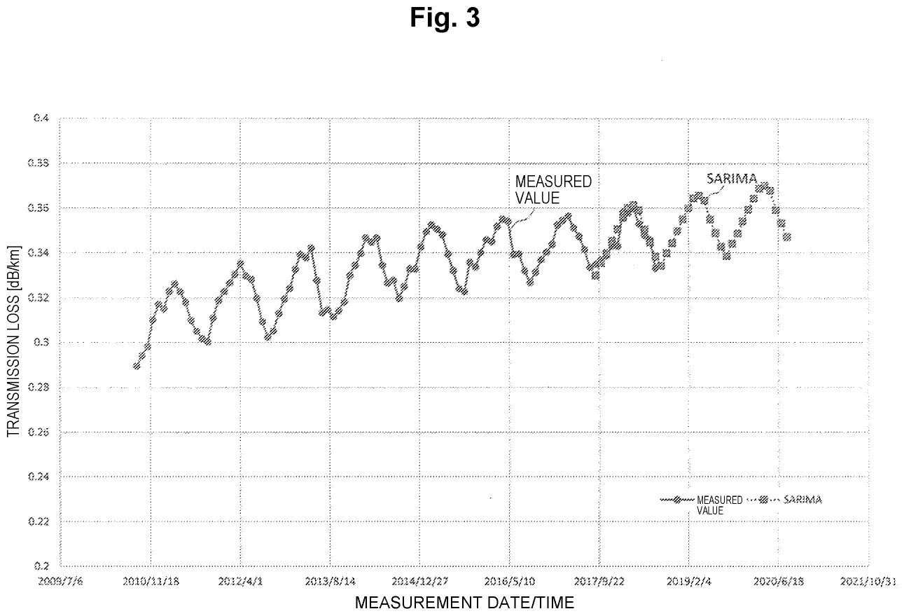

As illustrated in FIG. 3, a change over time of a transmission loss can be predicted with an autoregressive model in which the periodicity is taken into consideration. In FIG. 3, based on measured values from September, 2010 (hereinafter abbreviated as 2010/9) to 2017/8, the change over three years from 2017/9 is predicted. The prediction result can represent the periodicity of measured values in one year from 2017/9. The present disclosure can adopt a mode in which the influence of the transmission loss due to microbending is predicted using the periodicity of the change over time of the transmission loss.

Examples of the autoregressive model in which the periodicity is taken into consideration include a Seasonal AutoRegressive Integrated Moving Average (SARIMA) model. The SARIMA model is typically summarized in the form of SARIMA (p, d, q) (P, D, Q)[S]. Here, p represents the order of an autoregressive term, d represents the order of a difference, q represents the order of a moving average term, P represents the order of a seasonal autoregressive term, D represents the order of a seasonal difference, Q represents the order of a seasonal moving average term, and S represents a seasonal variation period. For example, 24 hours are selected as the period S when the periodicity in a day is taken into consideration, and 12 months are selected as the period S when the periodicity in a year is taken into consideration. The other orders may be set in advance, or an order with a minimum Akaike's information criterion (AIC) may be selected. Alternatively, the other orders may be selected such that an error between a number of most recently measured values and the predicted values is minimized after comparison. The order p is greater than or equal to “1”. The orders other than p are greater than or equal to “0”. The orders may be changed depending on the change over time of the transmission loss. As an approximation method using the periodicity, other than an approximation method using the autoregressive model, there is an approximation method using a trigonometric function, a linear approximation, a quadratic curve, or the like.

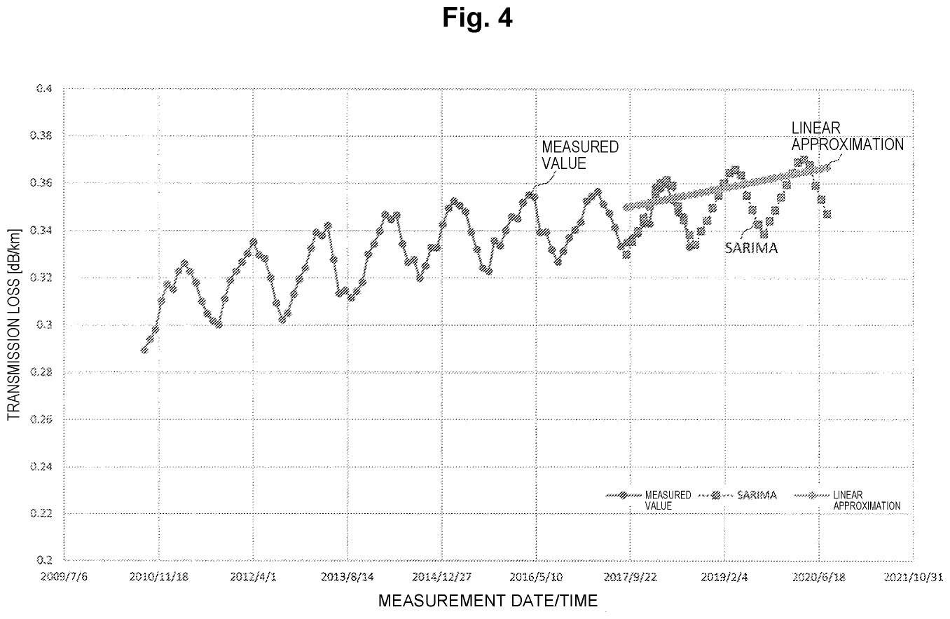

FIG. 4 illustrates an example of an error between an autoregressive model and a linear approximation when a change over time of a transmission loss is predicted. In the linear approximation, the change over three years from 2017/9 is predicted based on measured values from 2010/9 to 2017/8. It can be seen that the use of the autoregressive model makes it possible to predict the change with higher accuracy and less errors than in the linear approximation. The autoregressive model uses a case where the period S is 12 months and all the orders other than S are 1. A mean absolute error with the measured values during one year from 2017/9 in the autoregressive model is 0.003 dB/km, and a mean absolute error in the linear approximation is 0.009 dB/km, which is about three times that in the autoregressive model. In the autocorrelation model, a maximum error of 0.008 dB/km occurs in the relevant period, while in the linear approximation, an error of 0.022 dB/km, which is about three times that in the autocorrelation model, occurs. Thus, the change over time of the transmission loss can be predicted with high accuracy even when the change over time of the transmission loss is seasonal due to microbending.

<Measurement Method>

The influence of the change in transmission loss due to microbending increases as a wavelength increases. Accordingly, in detection of microbending, it is desirable to use an OTDR with a longer measurement wavelength. In the prediction, a measurement wavelength equivalent to a communication wavelength of a transmission device is desirably used. Therefore, the present disclosure can adopt a mode in which a communication wavelength is used to predict a transmission loss and a wavelength longer than the communication wavelength is used to detect microbending. In measurement of the transmission loss with the OTDR, it is desirable to perform additional averaging processing to reduce measurement noise. As the measured optical fiber, a core wire for maintenance may be used, or a free core wire may be used. If a test light reflection filter is installed in the transmission device, the measurement may be performed with a test light wavelength using an active core wire. The test light wavelength in a physical network is 1650 nm. The calculation of the transmission loss is desirably performed on each cable.

### First Embodiment

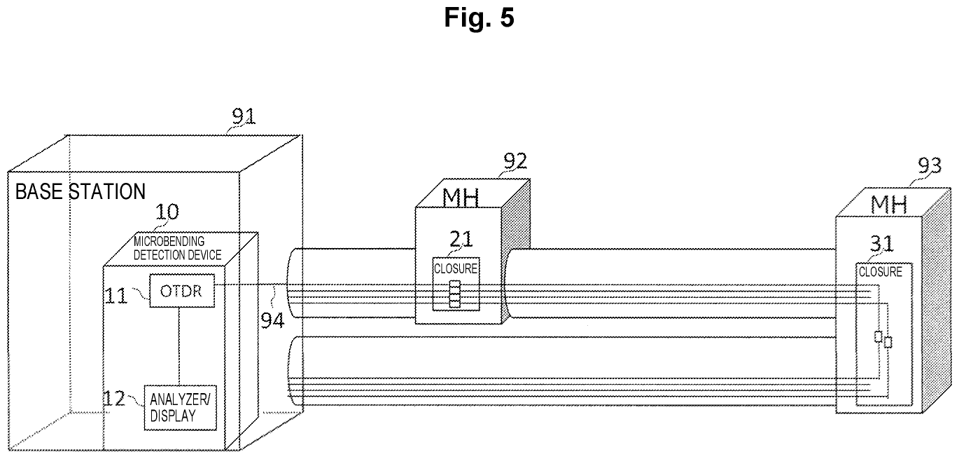

FIG. 5 illustrates a system configuration example according to the present disclosure. A microbending detection device 10 according to the present disclosure is disposed in a base station 91 and is connected to a measured optical fiber 94. In a first system configuration illustrated in FIG. 5, one end of the measured optical fiber 94 included in the cable is connected to the microbending detection device 10. While FIG. 5 illustrates an example where the microbending detection device 10 is connected to one cable, the microbending detection device 10 may be connected to a plurality of cables.

The microbending detection device 10 includes an OTDR 11 and an analyzer/display 12, and measures a transmission loss. The OTDR 11 emits measurement light to the measured optical fiber 94. The measurement light has any wavelength. The OTDR 11 detects scattered light of the measurement light scattered by the measured optical fiber 94. The analyzer/display 12 measures the transmission loss using the scattered light detected by the OTDR 11. The analyzer/display 12 includes an accumulation unit, and accumulates the measured transmission loss in the accumulation unit. Further, the analyzer/display 12 detects microbending in the measured optical fiber 94 using a periodic change in transmission loss. As described in the principle, microbending can be determined by calculating the periodicity using the autocorrelation for the change over time of the transmission loss. As described in the principle, the transmission loss can be predicted using the autoregressive model for the change over time of the transmission loss.

The analyzer/display 12 in the microbending detection device 10 of the present disclosure can also be implemented by a computer and a program, and the program can be recorded on a recording medium and can also be provided via a network.

The OTDR 11 measures a distance distribution of a transmission loss, thereby obtaining the result as illustrated in FIG. 1 at each point in a longitudinal direction of each cable. The periodicity for each cable is detected in the result obtained at each point, thereby making it possible to identify the cable in which microbending is detected and identify the distance from the microbending detection device 10. An installation location of the cable in which microbending is detected can be identified using a database in which distances from the microbending detection device 10 to each cable and installation locations of the cables are managed. Also, in prediction of a transmission loss, this processing is carried out on each cable and the installation location of the cable in which the transmission loss is predicted can be identified using the database in which distances from the microbending detection device 10 to each cable and installation locations of the cables are managed.

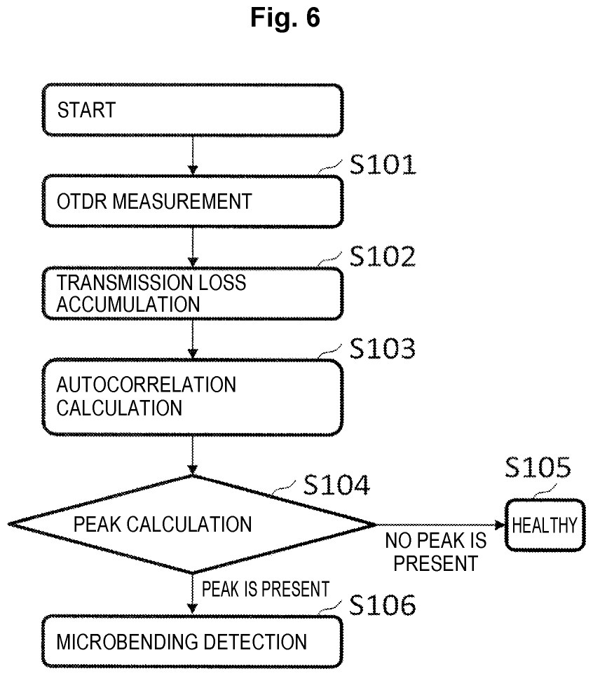

FIG. 6 illustrates an example of a microbending detection method of the present embodiment. The microbending detection method of the present embodiment includes an OTDR measurement procedure S101, a transmission loss accumulation procedure S102, an autocorrelation calculation procedure S103, a peak calculation procedure S104, a health detection procedure S105, and a microbending detection procedure S106.

In the OTDR measurement procedure S101, the OTDR 11 and the analyzer/display 12 measure a transmission loss in each cable.

In the transmission loss accumulation procedure S102, the analyzer/display 12 accumulates the transmission loss in each cable. An accumulation period is a preset period. Any period in which the presence or absence of periodicity of a transmission loss can be detected can be set as the accumulation period.

In the autocorrelation calculation procedure S103, the analyzer/display 12 calculates an autocorrelation coefficient of a change over time of the transmission loss.

In the peak calculation procedure S104, the presence or absence of a peak in a predetermined period, such as 12 months or 24 hours, is calculated based on the periodicity of the change over time of the transmission loss. The peak to be calculated is, for example, a period in which the value obtained by performing differentiation once crosses “0” in a negative direction from a positive value, or a period in which the value obtained by performing differentiation twice has the negative minimum value, in the vicinity of the predetermined period. Alternatively, the peak is a period in which the value obtained by performing differentiation three times crosses “0” in a positive direction from a negative value.

If there is no peak of the predetermined period in the periodicity of the change over time of the transmission loss, the analyzer/display 12 determines that it is in a healthy state in which microbending has not occurred in the measured optical fiber 94 (S105). If there is a peak of the predetermined period in the periodicity of the change over time of the transmission loss, the analyzer/display 12 determines that microbending has occurred in the measured optical fiber 94 (S106).

In the health detection procedure S105, the analyzer/display 12 displays information indicating the healthy state where microbending has not occurred in the measured optical fiber 94.

In the microbending detection procedure S106, the analyzer/display 12 displays information indicating that microbending has occurred in the measured optical fiber 94. In this case, the analyzer/display 12 may transmit an alarm to a predetermined address.

While the present embodiment illustrates an example where the autocorrelation calculation procedure S103 for calculating the autocorrelation coefficient to detect the presence or absence of the periodicity is executed, any method can be used to detect the periodicity. For example, the autocorrelation calculation procedure S103 may be a procedure for calculating the periodicity using Fourier transform. The health detection procedure S105 may include the microbending detection procedure S106 in which the transmission loss is compared with a predetermined threshold and then information indicating the healthy state is displayed when the transmission loss is less than or equal to the threshold and information indicating that microbending has occurred is displayed when the transmission loss is more than or equal to the threshold.

As described above, the microbending detection device 10 of the present embodiment can detect that microbending has occurred in the measured optical fiber 94. In this case, the use of the periodicity of the change over time of the transmission loss makes it possible to detect microbending before microbending affects the transmission loss when an initial value of the transmission loss is not set. Accordingly, the present disclosure can determine microbending in the measured optical fiber before microbending adversely affects the services. It is also considered that the present disclosure can deal with not only microbending that has occurred due to immersion, but also microbending that has occurred due to, for example, high temperature and high humidity.

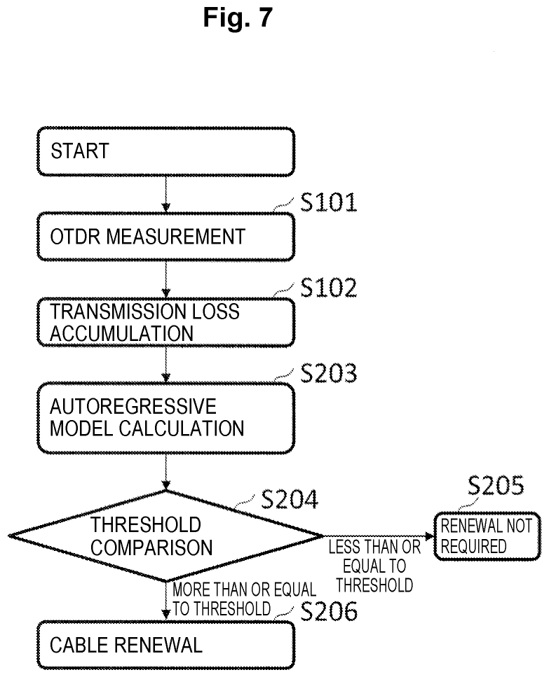

FIG. 7 illustrates an example of a method for predicting a change over time of a transmission loss due to microbending of the present embodiment. The transmission loss prediction method of the present embodiment includes the OTDR measurement procedure S101, the transmission loss accumulation procedure S102, an autoregressive model calculation procedure S203, a threshold comparison procedure S204, an undetected cable renewal detection procedure S205, and a cable renewal detection procedure S206.

In the autoregressive model calculation procedure S203, the analyzer/display 12 calculates an autoregressive model for the change over time of the transmission loss, and predicts the change over time of the transmission loss for a predetermined number of years ahead.

In the threshold comparison procedure S204, the predicted transmission loss is compared with a predetermined threshold. If the predicted transmission loss is less than the predetermined threshold, the analyzer/display 12 determines that there is no need to renew the cable for the measured optical fiber 94 for the predetermined number of years ahead (S205). If the predicted transmission loss is more than or equal to the predetermined threshold, the analyzer/display 12 determines that there is a need to renew the cable for the measured optical fiber 94 (S206).

In the undetected cable renewal detection procedure S205, the analyzer/display 12 displays information indicating a state where there is no need to renew the cable for the measured optical fiber 94 for the predetermined number of years ahead. In the cable renewal detection procedure S206, the analyzer/display 12 displays information indicating that there is a need to renew the cable for the measured optical fiber 94 within the predetermined number of years ahead. In this case, the analyzer/display 12 may display a prediction period that exceeds a threshold, or may transmit an alarm to a predetermined address.

While the present embodiment illustrates an example where the autoregressive model calculation procedure S203 for calculating the autoregressive model to predict the transmission loss is executed, any regression model can be used in consideration of the periodicity. For example, the autoregressive model calculation procedure S203 may be an approximation procedure using a trigonometric function, a linear approximation, a quadratic curve, or the like.

As described above, the microbending detection device 10 of the present embodiment can predict a change over time of a transmission loss in the measured optical fiber 94. In this case, the use of the autoregressive model makes it possible to predict the transmission loss with higher accuracy than in the prediction of the transmission loss by the linear approximation. Therefore, the present disclosure can estimate a cable renewal period with high accuracy. It is also considered that the present disclosure can deal with not only microbending that has occurred due to immersion, but also microbending that has occurred due to, for example, high temperature and high humidity.

In this case, it is desirable for the microbending detection device 10 to periodically execute the method of predicting a change over time of a transmission loss as described above. During such automatic measurement, in the cable renewal detection procedure S206, the analyzer/display 12 desirably transmits an alarm to a predetermined address.

In the case of managing the period before the cable is renewed during the periodic automatic measurement, it is desirable to reduce the measurement interval of the core wire in which microbending is determined to be present.

### Second Embodiment

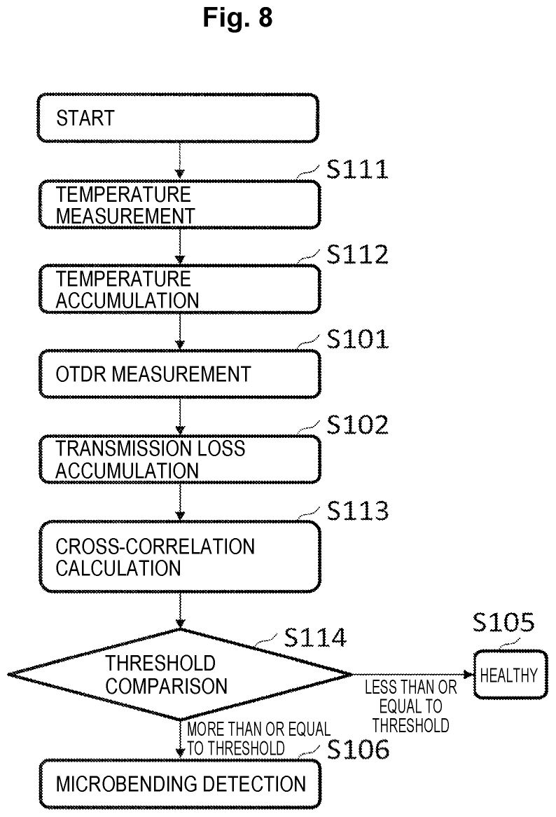

FIG. 8 illustrates a first example of the microbending detection method of the present embodiment. The microbending detection method of the present embodiment includes a temperature measurement procedure S111 and a temperature accumulation procedure S112 before the OTDR measurement procedure S101, includes a cross-correlation calculation procedure S113 instead of the autocorrelation calculation procedure S103, and includes a threshold comparison procedure S114 instead of the peak calculation procedure S104.

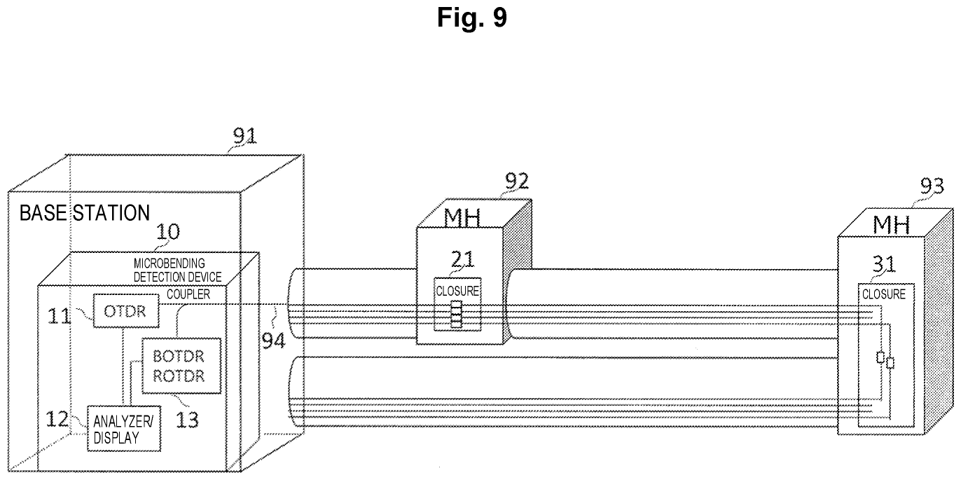

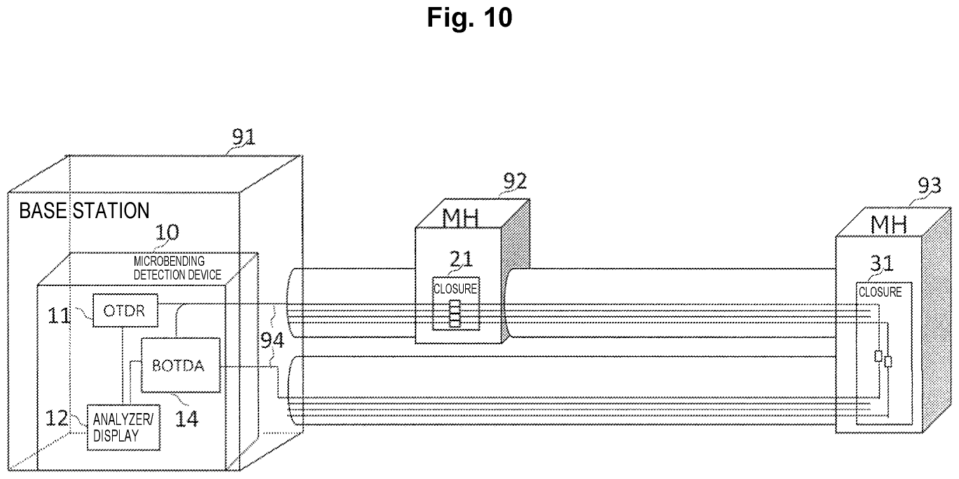

In the temperature measurement S111, like in a mode illustrated in FIG. 9, a Brillouin Optical Time Domain Reflectometer (BOTDR) or Raman Optical Time Domain Reflectometry (ROTDR) 13 measures Brillouin scattering or Raman scattering in the measured optical fiber 94, and the analyzer/display 12 measures a distance distribution at a temperature in the measured optical fiber 94 using a Brillouin scattering spectrum or a Raman scattering spectrum. Alternatively, like in a mode illustrated in FIG. 10, a BOTDA 14 may measure a gain or a loss due to Brillouin scattering in the measured optical fiber 94, and the analyzer/display 12 may measure a distance distribution at a temperature in the measured optical fiber 94 using a Brillouin scattering spectrum. If the temperature change in the measured optical fiber 94 has the same tendency as an outdoor temperature, a change over time of the outdoor temperature may be used. The measured temperature is accumulated in the accumulation unit included in the analyzer/display 12.

In the cross-correlation calculation procedure S113, the analyzer/display 12 calculates a cross-correlation coefficient between the change over time of the temperature in the measured optical fiber 94 and the change over time of the transmission loss measured in the OTDR measurement procedure S101.

In the threshold comparison procedure S114, the analyzer/display 12 compares the cross-correlation coefficient with a predetermined threshold. If the cross-correlation coefficient is less than the predetermined threshold, the analyzer/display 12 determines that it is in the healthy state where microbending has not occurred in the measured optical fiber 94 (S105). If the cross-correlation coefficient is more than or equal to the predetermined threshold, the analyzer/display 12 determines that microbending has occurred in the measured optical fiber 94 (S106).

A change in transmission loss due to microbending is dependent on temperature. Accordingly, when the analyzer/display 12 calculates a cross-correlation between the change over time of the transmission loss and the change over time of the temperature using the distance distribution at the measured temperature, there is a correlation between the transmission loss and the temperature.

While the present embodiment illustrates an example where the cross-correlation calculation procedure S113 using the cross-correlation between the change over time of the transmission loss and the change over time of the temperature is executed, any detection method may be used to detect the correlation between the transmission loss and the temperature. For example, a Fourier transform for the transmission loss may be compared with a Fourier transform for the temperature. The temperature measurement procedure S111 and the OTDR measurement procedure S101 may be carried out in any order, or may be simultaneously carried out. The period in which temperature measurement results are accumulated may be the same as the period in which transmission losses are accumulated.

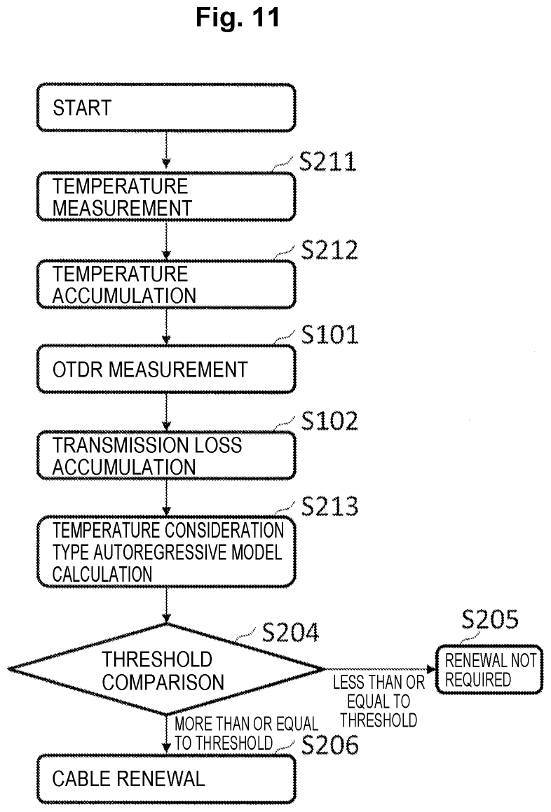

FIG. 11 illustrates an example of a method for predicting a change over time of a transmission loss due to microbending of the present embodiment. The transmission loss prediction method of the present embodiment includes a temperature measurement procedure S211 and a temperature accumulation procedure S212 before the OTDR measurement procedure S101, and includes a temperature consideration type autoregressive model calculation procedure S213 instead of the autoregressive model calculation procedure S203.

In the temperature consideration type autoregressive model calculation procedure S213, the analyzer/display 12 calculates an autoregressive model for the change over time of the transmission loss using the change over time of the temperature as an exogenous variable, and predicts the change over time of the transmission loss for a predetermined number of years ahead.

In the threshold comparison procedure S204, the transmission loss predicted in the procedure S213 is compared with a predetermined threshold. The subsequent procedures are similar to those of the first embodiment.

### INDUSTRIAL APPLICABILITY

The present disclosure is applicable to information communication industries.

### REFERENCE SIGNS LIST

10 microbending detection device
11 OTDR
12 analyzer/display
13 BOTDR/ROTDR
14 BOTDA
21, 31 closure
91 base station
92, 93 manhole
94 measured optical fiber

1. A device that measures a transmission loss in a measured optical fiber to be targeted, and detects microbending in the measured optical fiber based on periodicity of a change over time of the transmission loss.

2. A method comprising:
measuring, by a device, a transmission loss in a measured optical fiber to be targeted; and
detecting, by the device, microbending in the measured optical fiber based on periodicity of a change over time of the transmission loss.

3. The method according to claim 2, wherein the device obtains an autocorrelation coefficient for the change over time of the transmission loss, and detects the periodicity using the obtained autocorrelation coefficient.

4. The method according to claim 2, wherein the device obtains an autoregressive model for the change over time of the transmission loss, and predicts the change over time of the transmission loss using the obtained autoregressive model.

5. The method according to claim 2,
wherein the device further measures a temperature of the measured optical fiber, and
wherein the device detects the periodicity using a cross-correlation coefficient between a result of the measurement and the change over time of the transmission loss.

6. The method according to claim 2,
wherein the device further measures a temperature of the measured optical fiber, and
wherein the device predicts the change over time of the transmission loss using a result of the measurement and an autoregressive model for the change over time of the transmission loss.

7. The method according to claim 4, wherein the autoregressive model is a Seasonal AutoRegressive Integrated Moving Average (SARIMA) model.

8. A non-transitory computer-readable medium having computer-executable instructions that, upon execution of the instructions by a processor of a computer, cause the computer to function as the method according to claim 2.
